(19) United States
(12) Patent Application Publication
(10) Pub. No.: US 2016/0298369 A1
(43) Pub. Date: Oct. 13, 2016

(54) Brake Shoe and Stop that Interlock to Prevent Window Sash Drift During Use

(71) Applicant: John Evans' Sons, Inc., Lansdale, PA (US)

(72) Inventor: John R. Kunz, Douglassville, PA (US)

(73) Assignee: John Evans' Sons, Inc.

(21) Appl. No.: 15/159,780

(22) Filed: May 19, 2016

Related U.S. Application Data
(63) Continuation-in-part of application No. 15/093,727, filed on Apr. 7, 2016.
(60) Provisional application No. 62/144,898, filed on Apr. 8, 2015.
(60) Provisional application No. 62/165,177, filed on May 21, 2015.

(51) Int. Cl. E05C 17/60; E05D 15/16; E06B 3/44; E05D 13/00

(52) U.S. Cl. CPC E05D 13/04; E05D 13/12; E05D 15/165; E06B 3/4415; E05Y 2900/148

(57) ABSTRACT

A system and method for inhibiting inadvertent movement of a window sash out of a fully open position. The window sash is set in guide tracks. The window sash engages brake shoes that travel up and down in the guide tracks. A stop is mounted within the guide tracks. The brake shoe and the stop have a connector that joins the brake shoe to the stop when the window sash is moved to its fully open position. The brake shoe is separable from the stop when a closing force is manually applied to the window sash. The force applied must exceed a threshold level. In this manner, the window sash will remain in its fully open position and will not inadvertently drift closed due to gravity, vibrations, or friction with another window sash.

### RELATED APPLICATIONS

This application is a continuation-in-part of co-pending patent application Ser. No. 15/093,727, which claims the priority of 62/144,898 filed Apr. 8, 2015.

This application also claims priority of U.S. Provisional application No. 62/165,177 filed May 21, 2015.

### BACKGROUND OF THE INVENTION

1. Field of the Invention

In general, the present invention relates to counterbalance systems for windows that prevent open window sashes from moving under the force of their own weight. More particularly, the present invention system relates to the structure of both the brake shoe and the spring mount components of the counterbalance system that interconnect to inhibit the unintentional movement, known as drift, of a window sash that has been fully open.

2. Description of the Prior Art

There are many types and styles of windows. One of the most common types of window is the double-hung window. Double-hung windows are the window of choice for most home construction applications. A double-hung window consists of an upper window sash and a lower window sash. Either the upper window sash or the lower window sash can be selectively opened and closed by a person sliding the sash up and down within the window frame.

The sash of a double-hung window has a weight that depends upon the materials used to make the window sash and the size of the window sash. Since the sashes of a double-hung window are free to move up and down within the frame of a window, some counterbalancing system must be used to prevent the window sashes from constantly moving to the bottom of the window frame under the force of their own weight.

A popular variation of the double-hung window is the tilt-in double-hung window. Tilt-in double-hung windows have sashes that can be selectively moved up and down. Additionally, the sashes can be selectively tilted into the home so that the exterior of the sashes can be cleaned from within the home.

Modern tilt-in double-hung windows are primarily manufactured in one of two ways. There are vinyl frame windows and wooden frame windows. In the window manufacturing industry, different types of counterbalance systems are traditionally used for vinyl frame windows and for wooden frame windows. The present invention is mainly concerned with the structure of vinyl frame windows. As such, the prior art concerning vinyl frame windows is herein addressed.

Vinyl frame, tilt-in, double-hung windows are typically manufactured with guide tracks along the inside of the window frame. Brake shoe assemblies, commonly known as “shoes” in the window industry, are placed in the guide tracks and ride up and down within the guide tracks. Each sash of the window has two tilt pins or tilt posts that extend into the shoes and cause the shoes to ride up and down in the guide tracks as the window sashes are opened or closed.

The shoes contain a brake mechanism that is activated by the tilt post of the window sash when the window sash is tilted inwardly away from the window frame. The shoe therefore locks the tilt post in place and prevents the base of the sash from moving up or down in the window frame once the sash is tilted open. Furthermore, the brake shoes are attached to coil springs inside the guide tracks of the window assembly. Coil springs are constant force springs, made from wound lengths of metal ribbon. The coil springs supply the counterbalance force needed to suspend the weight of the window sash.

Small tilt-in windows have small, relatively light window sashes. Such small sashes may only require a single coil spring on either side of the window sash to generate the required counterbalance forces. However, due to the space restrictions present in modern tilt-in window assemblies, larger springs cannot be used for heavier window sashes. Rather, multiple smaller coil springs are ganged together to provide the needed counterbalance force. A large tilt-in window sash may have up to eight coil springs to provide the needed counterbalance force.

The counterbalance force created by the coil spring is fairly constant. However, there is a slight decrease in the counterbalance force that occurs when the window sash is open to the fullest degree. In this position, the coil springs are nearly fully wound. As such, very little of the coil spring is stressed and is opposing the weight of the window sash. It is for this reason that when a window sash is fully open, it may close slightly without being touched. Gravity can cause a window sash to drift closed. Furthermore, when an upper window sash is open, it creates friction against the lower window sash that it passes. If the lower window sash is open, then the friction can cause the upper window sash to drift open.

A need therefore exists for a system that prevents a window from drifting away from its fully open position. This need is met by the present invention as described and claimed below.

### SUMMARY OF THE INVENTION

The present invention is a system and method for inhibiting inadvertent movement of a window sash out of a fully open position. The window sash is set in guide tracks that run along the sides of the overall window assembly. The window sash is a tilt-in window with pivot posts that engage brake shoes. The brake shoes travel up and down in the guide tracks as the window sash is moved between a fully open position and a fully closed position.

A stop is mounted within the guide tracks. The brake shoe and the stop have a connector that joins the brake shoe to the stop when the window sash is moved to its fully open position. The connection made the connector is tenuous. The brake shoe is separable from the stop when a closing force is manually applied to the window sash that acts to move the window sash away from its fully open position. The force applied must exceed a threshold level. In this manner, the window sash will remain in its fully open position and will not inadvertently drift closed due to gravity, vibrations, or friction with another window sash.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is an end view showing an exemplary embodiment of a counterbalance system in a guide track of a tilt-in window;

FIG. 2 is an exploded perspective view of the primary components of the counterbalance system;

FIG. 3 shows the embodiment of FIG. 2 with the brake shoe and stop mount engaged and without the coiled ribbon springs;

FIG. 4 is a cross-sectional view of the embodiment shown in FIG. 3;

FIG. 5 shows an alternate embodiment for the connector between the brake shoe and the stop mount;

FIG. 6 shows an alternate embodiment for the connector between the brake shoe and the stop mount;

FIG. 7 shoes an alternate embodiment for the connector between the brake shoe and the stop mount;

FIG. 8 shoes an alternate embodiment for the connector between the brake shoe and the stop mount.

### DETAILED DESCRIPTION OF THE INVENTION

The features of the present invention counterbalance system can be incorporated into many window designs. However, the illustrations provided only show a few exemplary embodiments of the counterbalance system for the purpose of description. The embodiments illustrated are selected in order to set forth some of the best modes contemplated for the invention. The illustrated embodiments, however, are merely exemplary and should not be considered limitations when interpreting the scope of the claims.

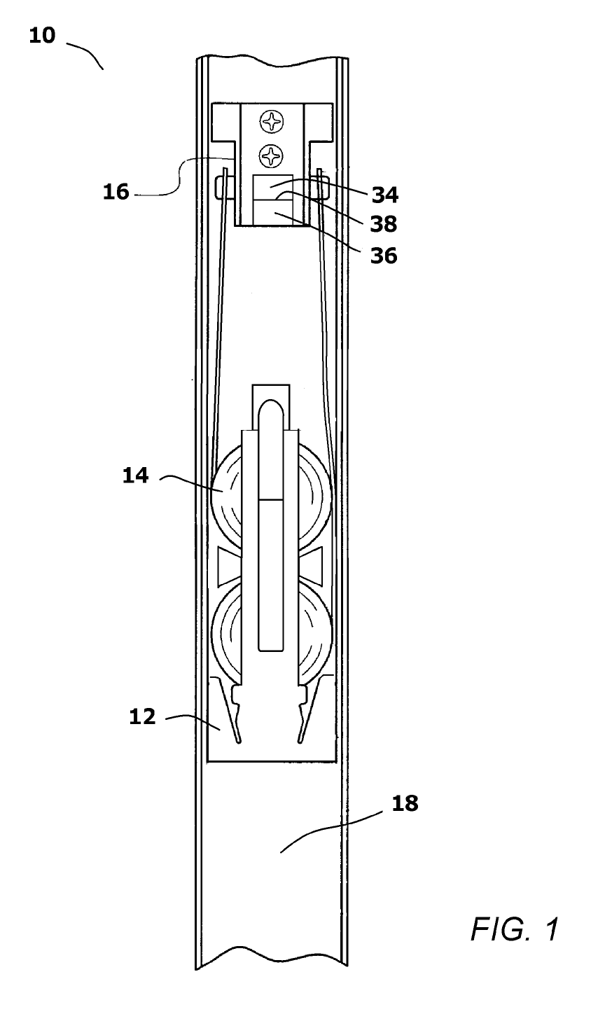

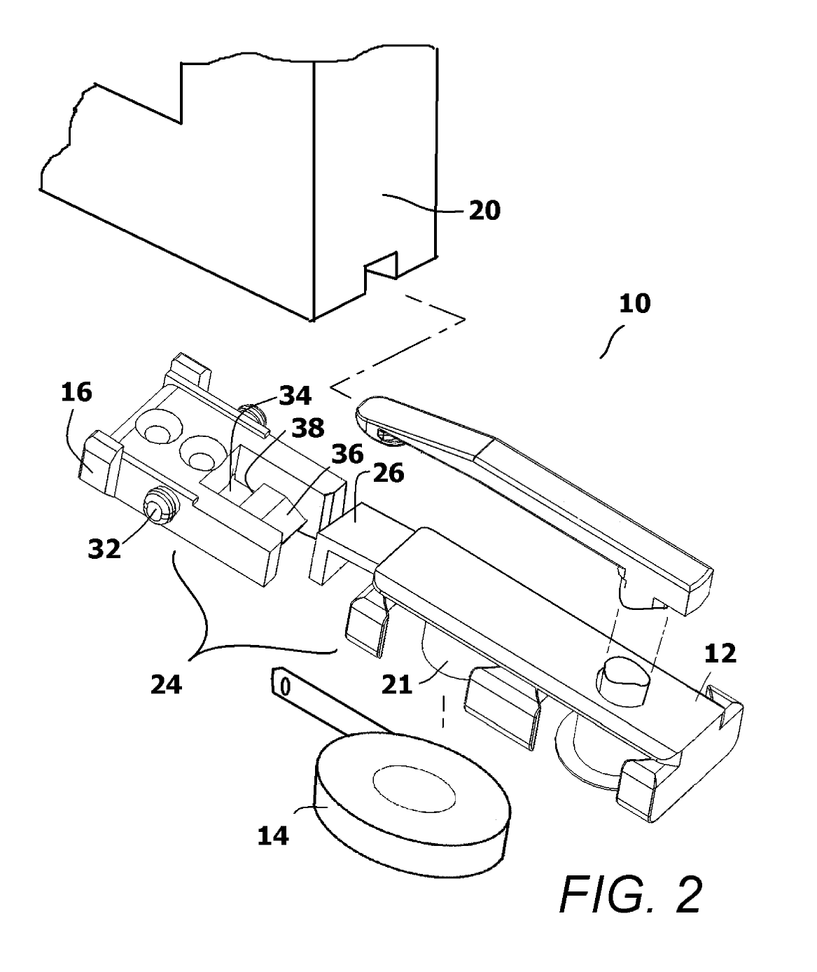

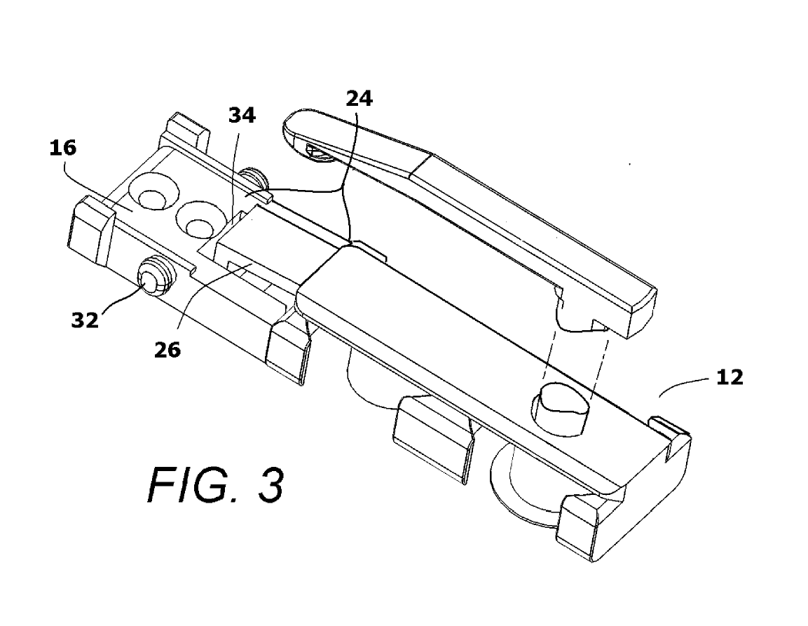

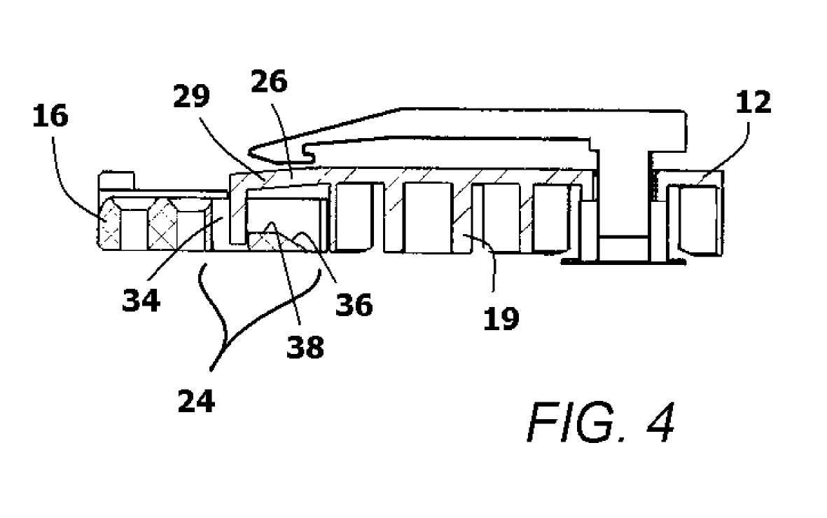

Referring to FIG. 1, in conjunction with FIG. 2, FIG. 3 and FIG. 4, there is shown a first exemplary embodiment of a counterbalance system 10 that is used to counterbalance the sashes contained within a window assembly. The counterbalance system 10 utilizes a brake shoe 12 that supports one or more coiled ribbon springs 14. The counterbalance system 10 also includes a stop mount 16 that attaches to the frame of the window in the window guide track 18. It will be understood that each window sash typically utilizes two counterbalance systems on opposite sides of a window sash 20. However, for the sake of simplicity and clarity, only one counterbalance system 10 is being illustrated.

The brake shoe 12 rides up and down in the guide track 18 of the window assembly. The brake shoe 12 and the window sash 20 it supports are pulled upwardly within the guide track 18 by the coiled ribbon springs 14. The coiled ribbon springs 14 rotate around spool posts 21 that extend from the brake shoe 12.

A tilt arm 22 extends into the brake shoe 12. The tilt arm 22 clips into the window sash 20, therein interconnecting the window sash 20 with the brake shoe 12. When the window sash 20 is tilted, the tilt arm 22 turns and causes the brake shoe 12 to lock in place in the guide track 18.

When the window sash 20 is opened to its fullest extent, the coiled ribbon springs 14 are nearly fully wound on the spool posts 21. In this fully open position, the brake shoe 12 contacts the stop mount 16. The presence of the stop mounts 16 prevents any further movement of the brake shoe 12 beyond the fully open position. However, the mere presence of the stop mount 16 does not prevent the brake shoe 12 from drifting away from the stop mount 16, therein causing the window sash 20 to move away from its fully open position.

To prevent the brake shoe 12, and the window sash 20 it supports, from drifting away from the stop mount 16, an interconnection is created between the stop mount 16 and the brake shoe 12 that physically prevents the brake shoe 12 from inadvertently drifting away from the stop mount 16. In FIG. 1 through FIG. 4, the interconnection between the brake shoe 12 and the stop mount 16 is created by a mechanical connector 24.

The mechanical connector 24 includes a flexible locking finger 26 that protrudes from the first end of the brake shoe 12. The locking finger 26 has a flexible neck 29 and a shaped head 30 that extends from the flexible neck 29. The locking finger 26 and the flexible neck 29 form the male section of the mechanical connector 24. The interconnecting female section of the mechanical connector 24 is formed on the stop mount 16.

The stop mount 16 is anchored to the rear wall of the guide track 18. When the window sash 20 is opened, the brake shoe 12 moves up the guide track 18 until it contacts the stop mount 16. The stop mount 16 is set in a fixed location on the guide track 18 with screws. The stop mount 16 has anchor elements 32 that interconnect with the free ends of the coiled ribbon springs 14. In this manner, the stop mount 16 anchors the free ends of the coiled ribbon springs 14 and the coiled ribbon springs 14 act to bias the brake shoe 12 toward the stop mount 16. This bias counterbalances the force of gravity, which acts to move the window sash 20 away from the stop mount 16.

The female section of the mechanical connector 24 is configured as a depression 34 that is formed into the stop mount 16. The depression 34 presents an inclined surface 36 at the bottom edge of the stop mount 16. The inclined surface 36 extends into the depression 34 and terminates with a ledge 38. When the window sash 20 is fully open, the locking finger 26 from the brake shoe 12 comes into contact with the stop mount 16. The locking finger 26 advances over the inclined surface 36, wherein the shaped head 30 moves over the inclined surface 36 and passes over the ledge 38. The presence of the shaped head 30 latched over the ledge 38 completes the mechanical connector 24 that interconnects the brake shoe 12 and the stop mount 16. The interconnection provided by the mechanical connector 24 is sufficient to prevent the window sash 20 from drifting, due to gravity or contact with another sash. However, the interconnection is tenuous. The mechanical connector 24 can be separated by manually applying a separation force in excess of a designed threshold. The preferred threshold separation force corresponds to a downward force of between one and ten pounds being applied to the window sash 20. Such a downward force will separate the mechanical connector 24 and pull the brake shoe 12 free of the stop mount 16, wherein the window now functions in the traditional manner.

It will therefore be understood that the window sash 20 will operate in a completely ordinary manner until the window sash 20 is opened to its fullest extent. At that point, the brake shoe 12 interconnects with the stop mount 16. This interconnection prevents the window sash 20 from drifting closed. To close the window sash 20, a threshold force must be applied to the window sash 20 in a manner that acts to separate the interconnection. Once the threshold force is reached, the brake shoe 12 will separate from the stop mount 16 and the window sash 20 is free to close.

In the embodiment illustrated in FIG. 1 through FIG. 4, the male section of the mechanical connector 24 is positioned on the brake shoe 12 and the female section is positioned on the stop mount 16. It will be understood that such positions are arbitrary and can be reversed. What is of importance is that the mechanical connector 24 exists between the brake shoe 12 and the stop mount 16 so that the brake shoe 12 and the stop mount 16 automatically interconnect when brought into contact.

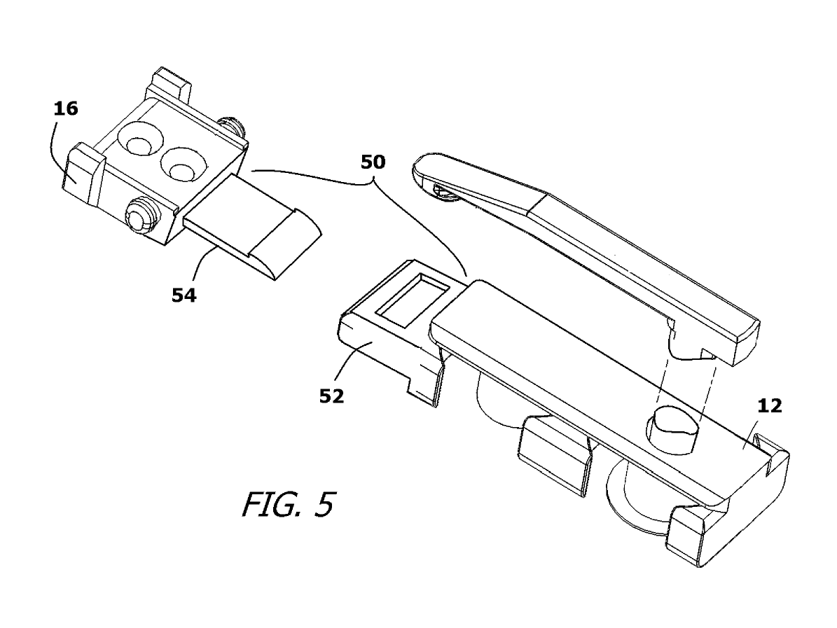

Referring to FIG. 5, an alternate embodiment of the mechanical connector 50 between the stop mount 16 and the brake shoe 12 is shown. In this embodiment, a female receptacle 52 is formed at the first end of the brake shoe 12. The female receptacle 52 is shaped and positioned to receive a locking finger 54 that extends from the stop mount 16. When the brake shoe 12 advances to the stop mount 16, the locking finger 54 enters the receptacle 52 and a mechanical interconnection is created. The mechanical connector 50 is designed to separate should a separating threshold force be applied.

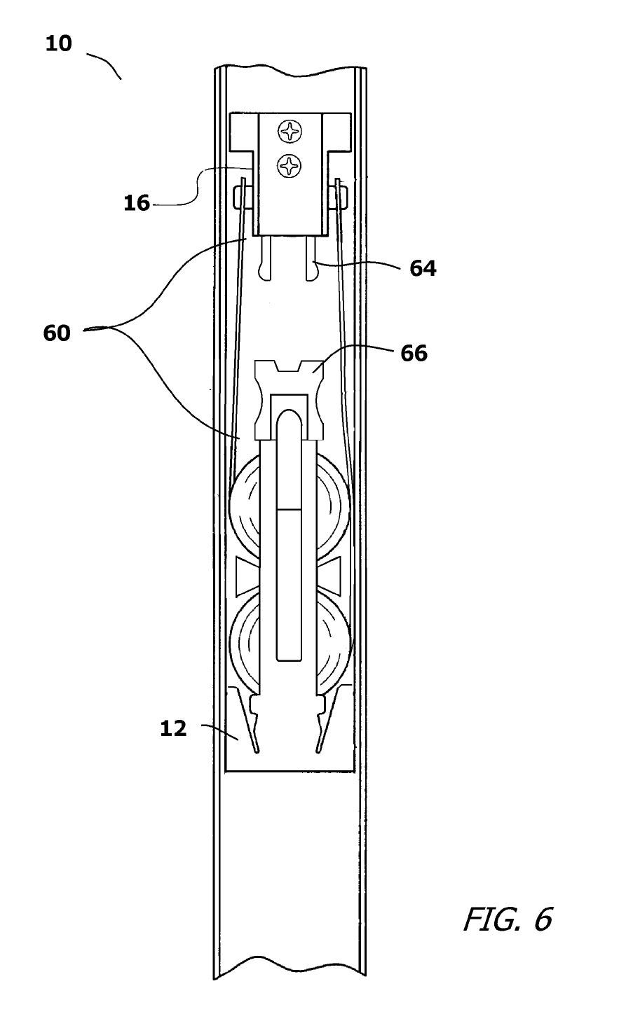

Referring to FIG. 6, another embodiment of the mechanical connector 60 between the stop mount 16 and the brake shoe 12 is shown. In this embodiment, the mechanical connector 60 is configured as a clip having two locking fingers 64 that extend into a female receptacle 66. The female receptacle 66 is formed at the first end of the brake shoe 12. The female receptacle 66 is shaped and positioned to receive the locking fingers 64 that extend from the stop mount 16. When the brake shoe 12 advances to the stop mount 16, the locking fingers 64 enter the receptacle 66 and a mechanical interconnection is created. The mechanical connector 60 is designed to separate should an appropriate separating threshold force be applied.

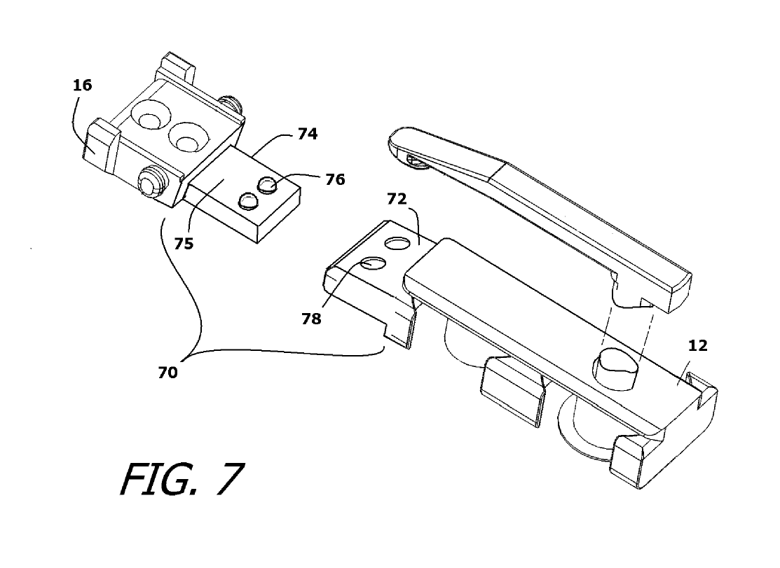

Referring to FIG. 7, another embodiment of the mechanical connector 70 is shown between the stop mount 16 and the brake shoe 12. In this embodiment, a female receptacle 72 is formed at the first end of the brake shoe 12. A male connector 74 is configured as a tab 75 that contains one or more spring-loaded ball bearings 76. The female receptacle 72 is shaped and positioned to receive a tab 75 and engage the ball bearings 76 with detents 78 that accept the ball bearings 76. When the brake shoe 12 advances to the stop mount 16, the tab 75 and ball bearings 76 enter the receptacle 72 and engage the ball detents 78. This creates a mechanical interconnection. The mechanical connector 70 is designed to separate should an appropriate separating threshold force be applied.

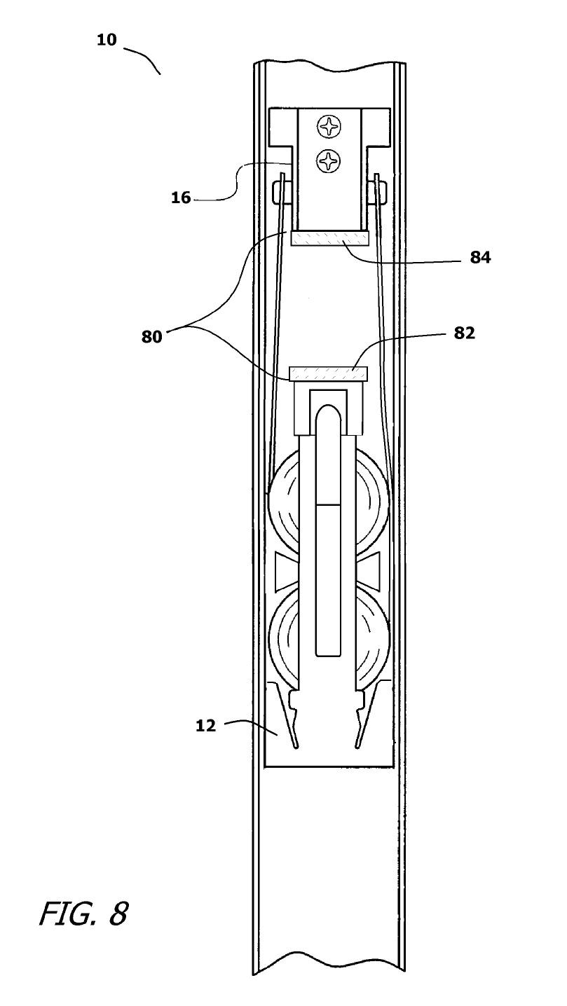

Referring to FIG. 8, an embodiment is shown that uses a magnetic connector 80 to create an interconnection between the stop mount 16 and the brake shoe 12. In this embodiment, a first magnet 82 is mounted to the first end of the brake shoe 12. A second magnet 84 is mounted to the stop mount 16. When the brake shoe 12 advances to the stop mount 16, the magnets 82, 84 interconnect. This creates a physical interconnection between the brake shoe 12 and the stop mount 16. The magnets 82, 84 are of a size and power that they separate should an appropriate separating threshold force be applied.

It will be understood that the embodiments of the present invention counterbalance system that are described and illustrated herein are merely exemplary and a person skilled in the art can make many variations to the embodiments shown without departing from the scope of the present invention. All such variations, modifications, and alternate embodiments are intended to be included within the scope of the present invention as defined by the claims.

What is claimed is:

1. In a window having a window sash that travels in guide tracks as said window sash moves between a fully open position and a fully closed position, a system for inhibiting drift movement of said window sash out of said fully open position, said system comprising:
a brake shoe coupled to said window sash that moves in one of said guide tracks as said window sash is manually manipulated between said fully closed position and said fully open position;
a stop mounted to said one of said guide tracks at a fixed elevation, wherein said brake shoe and said stop contact when said brake shoe is in said fully open position; and
a connector that automatically interconnects, said brake shoe and said stop as said brake shoe and said stop come into contact, wherein said connector prevents said brake shoe from moving away from said stop until a threshold separating force is applied to said window sash to move said sash from said fully open position towards said fully closed position.

2. The system according to claim 1, wherein said threshold force is between one pound and ten pounds.

3. The system according to claim 1, wherein said connector is a mechanical connector that mechanically interconnects said brake shoe and said stop.

4. The system according to claim 3, wherein said mechanical connector includes a male section and a female section that mechanically interconnect.

5. The system according to claim 4, wherein said male section includes at least one extending locking finger and said female part includes at least one receptacle for receiving and engaging said at least one extending locking finger.

6. The system according to claim 3, wherein said mechanical connector includes a male section and a female section that interconnect, wherein a ball and detent engage when said male section and said female section interconnect.

7. The system according to claim 1, wherein said connector is a magnetic connector that magnetically interconnects said brake shoe and said stop.

8. The system according to claim 1, further including at least one counterbalance spring that biases said brake shoe toward said stop.

9. The system according to claim 8, wherein said at least one counterbalance spring is connected to both said brake shoe and said stop.

10. In a window having a window sash that can move in guide tracks between a fully open position and a fully closed position, a system for inhibiting inadvertent movement of said window sash out of said fully open position, said system comprising:
a brake shoe coupled to said window sash that move in one of said guide tracks;
a stop mounted within said one of said guide tracks; and
a connector that causes said brake shoe and said stop to interconnect when said brake shoe is in said fully open position, and wherein said brake shoe is separable from said stop when a closing force is manually applied that acts to move said window sash toward said fully closed position.

11. The system according to claim 10, wherein said closing force is between one pound and ten pounds.

12. The system according to claim 10, wherein said connector is a mechanical connector that cause said brake shoe and said stop to mechanically interconnect when said window sash is in said fully open position.

13. The system according to claim 12, wherein said mechanical connector includes a male section and a female section that mechanically interconnect.

14. The system according to claim 13, wherein said male section includes at least one extending locking finger and said female section includes at least one receptacle for receiving and engaging said at least one extending locking finger.

15. The system according to claim 13, wherein said mechanical connector includes a male section and a female section that interconnect, wherein a ball and detent engage when said male section and said female section interconnect.

16. The system according to claim 10, wherein said connector is a magnetic connector that magnetically interconnects said brake shoe and said stop.

17. The system according to claim 10, further including at least one counterbalance spring that biases said brake shoe toward said stop.

18. The system according to claim 17, wherein said at least one counterbalance spring is connected to both said brake shoe and said stop.
